(19) United States
(12) Patent Application Publication
(10) Pub. No.: US 2006/0103309 A1
(43) Pub. Date: May 18, 2006

(54) Filter for a display device and flat panel display

(76) Inventors: Myun-Gi Shim, Suwon-si (KR); Ik-Chul Lim, Suwon-si (KR); Dong-Gun Moon, Suwon-si (KR); Jun-Kyu Cha, Suwon-si (KR)

Correspondence Address: LEE & MORSE, P.C., 1101 WILSON BOULEVARD, SUITE 2000, ARLINGTON, VA, 22209, US

(21) Appl. No.: 11/274,412

(22) Filed: Nov. 16, 2005

(30) Foreign Application Priority Data
Nov. 16, 2004 (KR) 10-2004-0093499

(51) Int. Cl. H01J 17/49

(52) U.S. Cl. 313/582; 313/112

(57) ABSTRACT

A filter for a display has a first film member that includes a pigment layer that absorbs a light of a certain wavelength band, a second film member that includes an electromagnetic wave absorption layer, and a third film member that includes a specular reflection preventing layer containing a plurality of diffusing elements, and a display apparatus employing such a filter is provided.

### BACKGROUND OF THE INVENTION

1. Field of the Invention

The invention relates to a filter for a display device and a display device including the filter. More particularly, the invention relates to a filter for reducing, and preferably preventing, specular reflection from occurring, and a display device including such a filter.

2. Description of the Related Art

A filter may be disposed in front of a display device such as a plasma display panel, a liquid crystal display (LCD) panel, or a cathode ray tube (CRT). The filter may improve the quality of the image display by, for example, shielding electromagnetic waves that are harmful to human beings, blocking neon emission, and preventing external light from being reflected onto a surface of the panel. The filter has a multi-layered structure.

FIG. 1 illustrates an exploded perspective view of a general plasma display apparatus.

As shown in FIG. 1, the plasma display apparatus includes a panel 11, a chassis 12, and an electronic circuit board 13. The panel 11 includes a front glass substrate 11a and a rear glass substrate 11b. The electronic circuit board 13 is attached to a rear surface of the chassis 12.

The chassis 12 is arranged between the panel 11 and the electronic circuit board 13. A glass filter 15 is installed in front of the panel 11. The panel 11, the chassis 12, and the glass filter 15 are installed in a space defined by a front cover 16 and a rear cover 14.

FIG. 2 illustrates a cross-sectional view of a transparent conductive layer of the glass filter 15 illustrated in FIG. 1.

As shown in FIG. 2, the glass filter 15 includes multiple films attached to a surface of a glass 21. A first film 24 is attached to a first surface of the glass 21 using an adhesive layer 23. A pigment layer 24a is formed on the first film 24. The pigment layer 24a is formed using a pigment that can absorb near-infrared rays and neon emission. A second film 25 is attached to a second surface of the glass 21 using an adhesive layer 22.

An electromagnetic wave absorption layer 26 is formed on the second film 25. The electromagnetic wave absorption layer 26 may be a mesh formed of a metal having high conductivity or a transparent thin film.

The electromagnetic wave absorption layer 26 includes a connection portion 26a on a side thereof. The electromagnetic wave absorption layer 26 absorbs the electromagnetic waves generated due the image being displayed on the plasma display apparatus. The electromagnetic waves that are absorbed by the electromagnetic wave absorption layer 26 are grounded through the connection portion 26a.

A third film 28 is attached onto a surface of the electromagnetic wave absorption layer 26 via an adhesive layer 27. A reflection prevention layer 28a is formed on the third film 28. The reflection prevention layer 28a is provided to help reduce reflection of external light on the glass filter 15. That is, the reflection prevention layer 28a is provided to help reduce degradation of the quality of images being displayed by the plasma display apparatus. The glass filter 15 is spaced about 5 mm to about 10 mm apart from the surface of the panel 11.

Plasma display panels or LCD panels are thinner and generally lighter than other display apparatus. If the thickness or weight of a plasma display apparatus increases as a result of the glass filter 15, advantages of plasma display apparatus are compromised. For example, the glass filter 15 accounts for about 10% of the entire weight of a plasma display apparatus. The glass filter 15 also increases the thickness of the panel 11 because of the thickness of the filter 15 itself and because of the distance that exists between the glass filter 15 and the panel 11. Thus, by providing such a glass filter 15, the weight and the thickness of a plasma display apparatus are generally undesirably increased.

As discussed above, the glass filter 15 includes the reflection prevention layer 28a. The reflection prevention layer 28a has, however, a smooth surface. Thus, the reflection prevention layer 28a of the glass filter 15 is limited in the extent to which it can reduce the reflection amount.

### SUMMARY OF THE INVENTION

The invention provides a filter for a display apparatus and a plasma display apparatus including such a filter, which at least substantially overcomes one or more of the problems due to the limitations and disadvantages of the related art.

It is therefore a feature of an embodiment of the invention to provide a filter that has a reduced weight and thickness in comparison to known filters for display apparatus.

It is therefore another feature of an embodiment of the invention to provide a plasma display apparatus including a filter that has a reduced weight and thickness in comparison to known filters for plasma display apparatus.

It is therefore another feature of an embodiment of the invention to provide a filter for a display apparatus that reduces, and preferably completely prevents, specular reflection.

It is therefore another feature of an embodiment of the invention to provide a plasma display apparatus including a filter that reduces, and preferably completely prevents, specular reflection.

At least one of the above and other features and advantages of the invention may be realized by providing a filter for a display, the filter including a first film member including a pigment layer that absorbs a light of a predetermined wavelength band, a second film member including an electromagnetic wave absorption layer, and a third film member including a specular reflection preventing layer, where a plurality of diffusing elements are provided at a surface of the specular reflection preventing layer, and the specular reflection preventing layer is an outer surface of the filter and a viewing surface of the display.

The pigment layer may be formed of a pigment selected from the group consisting of a squarylium-based pigment, a cyanine-based pigment, a anthraquinone-based pigment, a phthalocyanine-based pigment, a methine-based pigment, and a pyrole-based pigment for shielding neon emission. The pigment layer may be formed of a pigment selected from the group consisting of an aminium-based pigment, an immonium-based pigment, an anthraquinone-based pigment, a phthalocyane-based pigment, a nickel complex pigment, or a polymethine-based compound pigment for shielding near-infrared rays.

The electromagnetic wave absorption layer may be a copper mesh or a conductive layer (e.g., silver or indium tin oxide).

The first film member, the second film member and the third film members may be secured to one another. The second film member may be arranged between the first film member and the third film member. The first film member may be arranged between the second film member and the third film member.

Diffusing elements may be bonded to the third film member by a transparent resin layer. The diffusing elements may include at least one of a plurality of transparent plastic particles dispersed in the transparent resin layer and a plurality of fine protrusions that are formed on an outer surface of the specular reflection preventing layer. The transparent plastic particles may be at least one of styrene beads or melamine beads.

Refractive indexes of the transparent resin layer and the transparent plastic particles may be different from a refractive index of the fine protrusions.

The fine protrusions may be formed of a SiO₂ material or an MgF₂ material, may have diameters of about 1 nm to about 1 mm, and may be arranged irregularly in some embodiments and regularly in other embodiments.

At least one of the above and other features and advantages of the invention may be realized by providing a plasma display apparatus that includes a panel, and a filter in front of the panel, wherein the filter includes a first film member including a pigment layer that absorbs a light of a certain wavelength band, a second film member including an electromagnetic wave absorption layer, and a third film member including a specular reflection preventing layer, where a plurality of diffusing elements are provided at a surface of the specular reflection preventing layer, and the specular reflection preventing layer is an outer surface of the filter.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates an exploded perspective view of a conventional plasma display apparatus;

FIG. 2 illustrates a schematic cross-sectional view of a transparent conductive layer structure of a glass filter of the plasma display apparatus illustrated in FIG. 1;

FIG. 3 illustrates a schematic perspective view of a plasma display panel including a filter for a display device according to an exemplary embodiment of the invention;

FIG. 4 illustrates a schematic cross-sectional view of a transparent conductive layer of the filter illustrated in FIG. 3; and

FIG. 5 illustrates an enlarged cross-sectional view of a reflection prevention layer of the transparent conductive layer illustrated in FIG. 4.

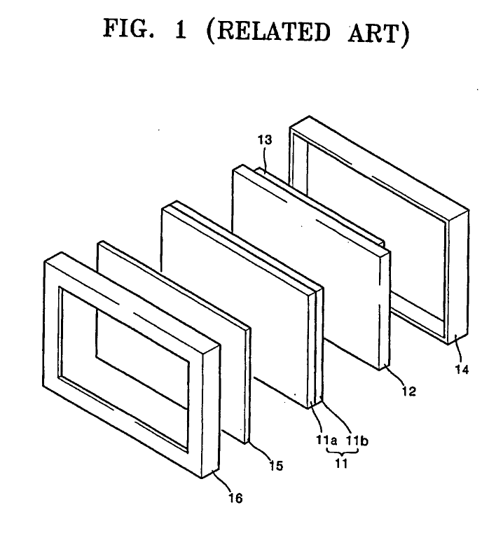

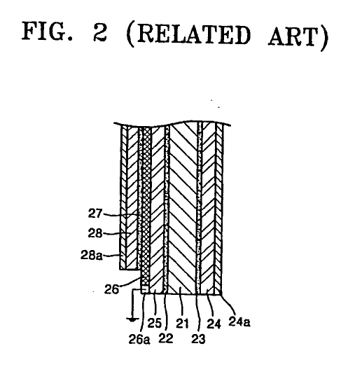

### DETAILED DESCRIPTION OF THE INVENTION

Korean Patent Application No. 10-2004-0093499, filed on Nov. 16, 2004, in the Korean Intellectual Property Office, and entitled: “Filter for Display Device and Flat Panel Display Including the Same,” is incorporated by reference in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration.

Like reference numerals refer to like elements throughout the description.

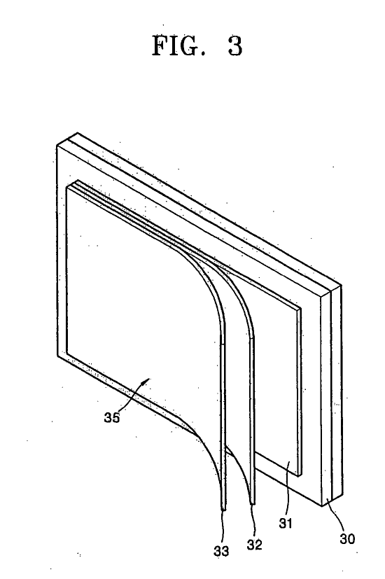

FIG. 3 illustrates a schematic perspective view of a plasma display panel including a filter for display according to an exemplary embodiment of the invention.

As illustrated in FIG. 3, a filter 35 for a display device employing one or more aspects of the invention is attached to a surface of a panel 30. In such embodiments, the panel 30 is a plasma display panel formed, for example, by bonding a front glass substrate and a rear glass substrate to each other. However, the panel 30 may, for example, be a panel in an LCD apparatus, or a CRT.

The filter 35 may be formed by stacking a plurality of films 31, 32, and 33, as shown in FIG. 3. The filter 35 may be directly attached to the surface of the panel 30. For example, the filter 35 may be formed by stacking a first film 31, a second film 32, and a third film 33 with adhesive layers between them. The surfaces of the first film 31, the second film 32, and the third film 33 may have been treated to perform desired functions.

The first film 31, the second film 32 and the third film 33 may be formed, for example, of polyethylene terephthalate (PET) or triacetyle cellulose (TAC).

FIG. 4 illustrates a cross-sectional view of a transparent conductive layer structure of the filter 35 that is shown in FIG. 3.

As shown in FIG. 4, a pigment layer 31a may be formed on a first surface of the first film 31. In some embodiments, the pigment layer 31a may absorb, for example, neon light (about 590 nm) or near-infrared rays (about 850 nm to about 1000 nm). When the pigment layer 31a absorbs neon light, the reproduced colors and the color temperatures may be improved. When the pigment layer 31a absorbs the near-infrared rays, improper operations of electronic appliances such as a remote controller can be reduced and preferably prevented.

The neon light absorbing pigment may be, for example, a squarylium-based pigment, a cyanine-based pigment, an anthraquinone-based pigment, a phthalocyanine-based pigment, a methine-based pigment, or a pyrole-based pigment. An aminium-based pigment, an immonium-based pigment, an anthraquinone-based pigment, a phthalocyane-based pigment, a nickel complex pigment, or a polymethine-based compound pigment may be used, for example, as the near-infrared ray absorption pigment.

One or more pigments among the above pigments may be selected, for example, and coated on the first surface of the first film 31 to form the pigment layer 31a. An adhesive layer 41 may be formed on the pigment layer 31a. The adhesive layer 41 may be used to attach the pigment layer 31a directly onto the surface of the panel 30, as illustrated in FIG. 3, or to attach the pigment layer 31a onto other shock absorption layers (not shown).

A second film 32 may be attached onto a second surface of the first film 31 via an adhesive layer 42. An electromagnetic wave absorption layer 36 may be formed on the second film 32. The electromagnetic wave absorption layer 36 may absorb electromagnetic waves generated when the panel 30 displays an image. The electromagnetic wave absorption layer 36 may be a mesh formed of a material having high conductivity or a transparent conductive layer. The electromagnetic wave absorption layer 36 may be formed, for example, of a copper (Cu), a silver (Ag), or a metal oxide of an indium tin oxide (ITO). The conductive material may be etched to form a fine mesh, or may be sputtered on the second film to form a transparent conductive layer. When the silver Ag or the ITO is formed as the electromagnetic wave absorption layer 36 having the transparent conductive layer structure, the electromagnetic wave absorption layer 36 may absorb the near-infrared rays.

A connection portion 43a may be formed on a side of the electromagnetic wave absorption layer 36. The connection portion 43a grounds the electromagnetic waves absorbed by the electromagnetic wave absorption layer 36.

A third film 33 may be attached to the electromagnetic wave absorption layer 36 through an adhesive layer 43. A specular reflection preventing layer 33a may be formed on the third film 33. The specular reflection preventing layer 33a reduces, and preferably prevents, the reflection of external light on a smooth surface of the filter 35.

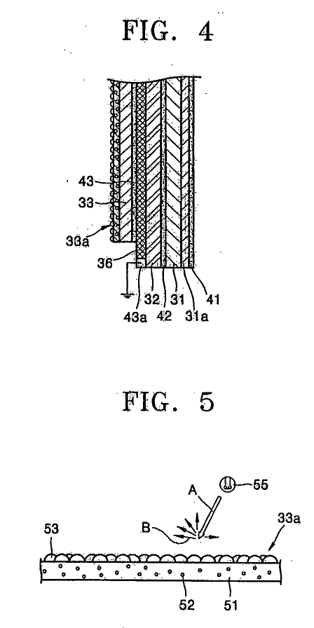

FIG. 5 illustrates a cross-sectional view enlarging the specular reflection preventing layer illustrated in FIG. 4.

Referring to FIG. 5, the specular reflection preventing layer 33a may be formed by dispersing transparent plastic particles 52 in a transparent resin layer 51. Alternatively, the specular reflection preventing layer 33a may be formed with a low refractive layer that includes fine protrusions 53 on the transparent resin layer 51. It is also possible to form the low refractive layer of the fine protrusions 53 on the transparent resin layer 51, which includes the transparent plastic particles 52. Either or both of the transparent plastic particles 52 or the fine protrusions 53 serve as diffusing elements to diffusely reflect light incident thereon, thereby reducing or eliminating specular reflection.

The transparent resin layer 51 may be attached to the third film 33, as shown in FIG. 4. The transparent plastic particles 52 may be dispersed in the transparent resin layer 51. The transparent plastic particles 52 may be styrene beads or melamine beads. In some embodiments, diameters of the transparent plastic particles 52 may be about 0.1 μm to about 3 μm.

In some embodiments, the thickness of the transparent resin layer 51 may be about 3 μm to about 10 μm.

A second coating layer may be formed on the transparent resin layer 51. The second coating layer may be fine protrusions 53 or a homogeneous thin layer (not shown). In some embodiments, the fine protrusions 53 may be formed, for example, of SiO₂ material or MgF₂ material, and the maximum diameter of the fine protrusions 53 may be, for example, about 1 nm to about 1 mm. The fine protrusions 53 may be arranged regularly or irregularly on the transparent resin layer 51. If the fine protrusions 53 are arranged regularly, they can be arranged in the form of grids or lines.

In order to form the transparent resin layer 51, transparent fine particles may be mixed in a resin layer and coated using, for example, a spray coating method, a roll coating method, or a deep coating method. A spray coating method may be used to form the fine protrusions 53 that are irregularly arranged. A casting method or a method using a photoresist may be used to form the fine protrusions 53 that are regularly arranged. Commercially available materials such as, for example, Chemisnow made by Soken Corp. may be used to form the transparent resin layer 51.

The transparent plastic particles 52 included in the transparent resin layer 51 and the fine protrusions 53 formed on the upper surface of the transparent resin layer 51 disperse light that is incident onto the filter 35. As shown in FIG. 5, when the light from an external light source 55, represented by arrow A, is incident onto the specular reflection preventing layer 33a, the light is dispersed into various directions represented by arrows B on the surface of the specular reflection preventing layer 33a. To increase the dispersion of the incident light, the fine protrusions 53 and the transparent plastic particles 52 may have different refractive indexes. The refractive index of the transparent resin layer 51 and the transparent plastic particles 52 may be, for example, about 1.2 to about 1.9, and the refractive index of the fine protrusions 53 may be different by at least about 0.01 more than the refractive index of the resin layer 51.

Ordering of the electromagnetic wave absorption layer 36 and the pigment layer 31a may be reversed from that shown in FIG. 4 according to another exemplary embodiment of the invention. For example, the filter may include a first film on which the electromagnetic wave absorption film is formed, a second film that is attached to the first film and on which a pigment layer absorbing the light having a certain wavelength is formed, and a third film attached to the second film and including the specular reflection preventing layer, on which a plurality of fine protrusions are provided. In the filter of this embodiment, positions of the first film and the second film may be changed.

One of a single homogeneous layer including resin and reflection preventing particles, a single anti-glare (AG) layer including particles formed as a rough surface, an AG layer having irregular particles on a homogeneous layer formed of particles dispersed in resin, and an even anti-reflection (AR) layer formed on a homogeneous layer formed of particles dispersed in resin may be used as a reflection preventing layer in a filter employing one or more aspects of the invention.

A filter employing one or more aspects of the invention can be attached directly onto the surface of the panel, and thus, weight and thickness of the panel are not increased. In addition, because the specular reflection preventing layer may be provided as part of the filter, degradation of image display due to specular reflection of the external light may be reduced, and preferably prevented.

Exemplary embodiments of the invention have been disclosed herein, and although specific terms are employed, they are used and are to be interpreted in a generic and descriptive sense only and not for purpose of limitation. Accordingly, it will be understood by those of ordinary skill in the art that various changes in form and details may be made therein without departing from the spirit and scope of the invention as set forth in the following claims.

What is claimed is:

1. A filter for a display, the filter comprising:
a first film member including a pigment layer that absorbs a light of a predetermined wavelength band;
a second film member including an electromagnetic wave absorption layer; and
a third film member including a specular reflection preventing layer having a plurality of diffusing elements, the specular reflection preventing layer being an outer surface of the filter and a viewing surface of the display.

2. The filter according to claim 1, wherein the pigment layer is formed of a pigment selected from the group consisting of a squarylium-based pigment, a cyanine-based pigment, a anthraquinone-based pigment, a phthalocyanine-based pigment, a methine-based pigment, a pyrole-based pigment, and mixtures and combinations thereof for shielding neon emission.

3. The filter as claimed in claim 1, wherein the pigment layer is formed of a pigment selected from the group consisting of an aminium-based pigment, an immonium-based pigment, an anthraquinone-based pigment, a phthalocyane-based pigment, a nickel complex pigment, a polymethine-based compound pigment, and mixtures and combinations thereof for shielding near-infrared rays.

4. The filter as claimed in claim 1, wherein the electromagnetic wave absorption layer is a copper mesh.

5. The filter as claimed in claim 1, wherein the electromagnetic wave absorption layer is a conductive layer.

6. The filter as claimed in claim 1, wherein the first film member, the second film member and the third film members are secured to one another.

7. The filter as claimed in claim 1, wherein the second film member is arranged between the first film member and the third film member.

8. The filter as claimed in claim 1, wherein the first film member is arranged between the second film member and the third film member.

9. The filter as claimed in claim 1, wherein the fine diffusing elements are bonded to the third film member by a transparent resin layer.

10. The filter as claimed in claim 9, wherein the diffusing elements include at least one of a plurality of transparent plastic particles dispersed in the transparent resin layer and a plurality of fine protrusions that are formed on an outer surface of the third film member.

11. The filter as claimed in claim 10, wherein the transparent plastic particles are at least one of styrene beads or melamine beads.

12. The filter as claimed in claim 10, wherein refractive indexes of the transparent resin layer and the transparent plastic particles are different from a refractive index of the fine protrusions.

13. The filter as claimed in claim 10, wherein the fine protrusions are formed of a SiO₂ material or a MgF₂ material.

14. The filter as claimed in claim 10, wherein the fine protrusions have diameters of about 1 nm to about 1 mm.

15. The filter as claimed in claim 10, wherein the fine protrusions are arranged irregularly.

16. The filter as claimed in claim 10, wherein the fine protrusions are arranged regularly.

17. A plasma display apparatus comprising:
a panel; and
a filter in front of the panel,
wherein the filter includes:
a first film member having a pigment layer that absorbs a light of a certain wavelength band;
a second film member having an electromagnetic wave absorption layer; and
a third film member having a specular reflection preventing layer containing a plurality of diffusing elements, the specular reflection preventing layer being an outer surface of the filter.

18. The filter as claimed in claim 17, wherein the first film member, the second film member and the third film members are secured to one another.

19. The filter as claimed in claim 17, wherein the second film member is arranged between the first film member and the third film member.

20. The filter as claimed in claim 17, wherein the first film member is arranged between the second film member and the third film member.

21. The filter as claimed in claim 17, wherein the fine diffusing elements are bonded to the third film member by a transparent resin layer.

22. The filter as claimed in claim 21, wherein the diffusing elements include at least one of a plurality of transparent plastic particles dispersed in the transparent resin layer and a plurality of fine protrusions that are formed on an outer surface of the third film member.
